(19) United States
(12) Patent Application Publication
(10) Pub. No.: US 2015/0262729 A1
(43) Pub. Date: Sep. 17, 2015

(54) SILVER-COATED COPPER POWDER, AND METHOD FOR PRODUCING SAME

(71) Applicant: MITSUI MINING & SMELTING CO., LTD., Tokyo (JP)

(72) Inventors: Shinji Aoki, Yamaguchi (JP); Masanori Tanaka, Yamaguchi (JP); Toshihiro Kohira, Yamaguchi (JP); Takahiko Sakaue, Yamaguchi (JP)

(73) Assignee: MITSUI MINING & SMELTING CO., LTD., Tokyo (JP)

(21) Appl. No.: 14/433,999

(22) PCT Filed: Nov. 8, 2013
(86) PCT No.: PCT/JP2013/080201

§ 371 Date: Apr. 7, 2015

(30) Foreign Application Priority Data
Nov. 30, 2012 (JP) 2012-261812

(51) Int. Cl. H01B 1/22; B05D 7/14; H01B 13/00; B22F 1/02; H01B 1/02

(52) U.S. Cl. CPC H01B 1/22; B22F 1/025; H01B 1/02; H01B 13/00; B05D 7/14

(57) ABSTRACT

A silver-coated copper powder includes copper core particles and a silver coat layer located on the surface of the core particles. When S₁ is a BET specific surface area (m²/g) of the silver-coated copper powder; S₂ is a specific surface area (m²/g) calculated from a particle diameter D₅₀ obtained by the analysis of a microscopic image of the silver-coated copper powder; and t is a thickness of the silver coat layer, the silver-coated copper powder satisfies Expression: (S₁/S₂)≦0.005×t+1.45. The silver-coated copper powder has a volume cumulative particle diameter D_{50L} at a cumulative volume of 50 vol % as measured by laser diffraction-scattering method of 0.01 to 100 μm.

### TECHNICAL FIELD

This invention relates to a silver-coated copper powder and a method for producing the same.

### BACKGROUND ART

Copper powder has been widely used as a raw material of conductive paste due to easy handling. Conductive paste finds a wide range of applications, from experimental to electronic industrial applications. In particular, a silver-coated copper powder having a silver coat layer on the surface of copper particles have been used in the form of conductive paste as a material for providing electrical conduction in, for example, the wiring of printed circuit boards using a screen printing and the formation of electrical contact points; for silver-coated copper powders are superior to ordinary copper powders in electrical conductivity. Silver-coated copper powders are less expensive and economically more advantageous than silver powder composed solely of silver. Therefore, use of a conductive paste containing a silver-coated copper powder having excellent conductivity characteristics allows for making a low resistance conductor at low cost.

Silver-coated copper powders have generally been manufactured by electroless displacement plating making use of displacement reaction between copper and silver. For example, Patent Literature 1 below discloses a method including vigorously stirring a solution containing copper metal powder and silver nitrate to precipitate metallic silver on the surface of copper metal powder particles. The assignee common to the present patent application previously proposed a method for producing a silver-coated copper powder by electroless displacement plating (see Patent Literature 2 below), in which copper powder is dispersed in an acidic solution thereby surely removing copper oxide from the surface of the copper particles prior to the displacement reaction with silver, and a chelating agent is added to a slurry of the thus treated copper powder, followed by adding a buffering agent to adjust the pH, followed by continuously adding a silver ion solution to the slurry thereby keeping the displacement reaction rate constant.

Apart from the above techniques, Patent Literature 3 below teaches a method including preparing a copper powder slurry having a pH of 3.5 to 4.5 by dispersing copper powder in a reducing agent and continuously adding a silver ion solution to the slurry thereby forming a silver layer on the surface of the copper particles through electroless displacement plating and electroless reductive plating. Examples of the reducing agent useful in that method include grape sugar (glucose), malonic acid, succinic acid, glycolic acid, lactic acid, malic acid, tartaric acid, oxalic acid, sodium potassium tartrate (Rochelle salt), and formalin.

### CITATION LIST

### Patent Literature

Patent Literature 1: JP 10-212501A
Patent Literature 2: JP 2004-052044A
Patent Literature 3: JP 2011-214080A

### SUMMARY OF INVENTION

The problem associated with displacement plating is that copper dissolves in place of reduced silver to form a large number of pores in the coating, through which oxidation-susceptible copper is exposed to the outside. As a result, oxidation proceeds with time, resulting in reduction of electroconductivity of the powder.

Accordingly, an object of the invention is to provide a silver-coated copper powder and a method for producing the same which eliminate the drawbacks of the above described conventional techniques.

The present invention provides a silver-coated copper powder including copper core particles and a silver coat layer located on the surface of the core particles and satisfying Expression:

(S₁/S₂)≦0.005×t+1.45

where S₁ is a BET specific surface area (m²/g) of the silver-coated copper powder; S₂ is a specific surface area (m²/g) calculated from a particle diameter D₅₀ obtained by the analysis of a microscopic image of the silver-coated copper powder; and t is a thickness of the silver coat layer.

The present invention also provides a method for producing a silver-coated copper powder including the steps of:

contacting copper core particles with silver ions in water to conduct displacement plating to obtain precursor particles having silver deposited on the surface of the copper core particles and

contacting the precursor particles with silver ions and a silver ion reducing agent in water to further deposit silver on the surface of the precursor particles,

the reducing agent having such reducing power that allows displacement plating and reductive plating with silver to proceed simultaneously.

### BRIEF DESCRIPTION OF DRAWING

FIG. 1 is a graph showing the relation between S₁/S₂ and t obtained in Examples and Comparative Examples.

### DESCRIPTION OF EMBODIMENTS

The present invention will be described generally based on its preferred embodiments. The silver-coated copper powder of the invention is an aggregate of silver-coated copper particles having core particles including copper (hereinafter copper core particles) covered with a layer of silver (hereinafter referred to as a silver coat layer). The silver coat layer continuously covers the surface of the copper core particles. Accordingly, the entire surface of the silver-coated copper particles is formed solely of silver, and the copper substrate is not at all exposed.

The silver-coated copper powder of the invention has one of its characteristics in the silver coat layer covering the copper core particles. Specifically, the silver coat layer is very dense layer with few pores. Being covered on the entire surface with such a silver coat layer, oxidation of the copper substrate is minimized. As a result, the silver-coated copper powder of the invention is prevented from the least increase in electrical resistance even after long-term storage. In contrast to this, the silver-coated copper powder particles of Patent Literatures 1 and 2 are considered to have a number of pores through the silver coat layer, through which the surface of the copper core particles is liable to connect to the open air. As a result, the copper tends to be oxidized during long-term storage, and the electrical resistance of the silver-coated copper powder is apt to increase. A method for forming a dense, relatively pore-free silver coat layer will be described later.

As described, one of the characteristics of the silver-coated copper powder of the invention resides in the dense silver coat layer. Although it is not easy to objectively represent the denseness of the silver coat layer, the inventor has revealed that an S₁/S₂ serves as a measure of the denseness of the silver coat layer, wherein S₁ is a BET specific surface area (m²/g) of the silver-coated copper powder, and S₂ is a specific surface area (m²/g) calculated from a particle diameter D₅₀ obtained by the analysis of a microscopic image of the silver-coated copper powder. The S₁/S₂ value has the following technical meaning. Since the S₂ is a specific surface area obtained through the image analysis of the silver-coated copper powder particles, the value does not depend on whether the silver coat layer is porous or pore-free. In other words, the S₂ is the specific surface area calculated based on the assumption that the silver coat layer is perfectly dense. On the other hand, the S₁ is an actual measurement value measured by the BET method that reflects the porosity of the silver coat layer. As the larger the number of the pores of the silver coat layer, the larger the S₁ tends to be. As is obvious from the above discussion, the closer the S₁/S₂ to 1, the fewer the number of the pores of the silver coat layer is believed to be. Conversely, as the S₁/S₂ moves away from 1, the number of the pores of the silver oat layer is considered to be greater.

As a result of further investigation by the inventor, it has turned out that the S₂/S₂ also depends on the thickness of the silver coat layer. When two kinds of silver-coated copper powders having the same pore density (the number of pores per unit volume) in the silver coat layer thereof and different silver coat layer thicknesses are compared, it has been found that the S₁/S₂ increases with the silver coat layer thickness.

The inventor has examined various silver-coated powders based on the above findings and ascertained as a result that a silver-coated copper powder satisfying Expression (1) shown below has a dense silver coat layer and is prevented from increasing the electrical resistance during long-term storage.

(S₁/S₂)≦0.005×t+1.45 (1)

With the provision that Expression (1) is satisfied, the thickness of the silver coat layer is preferably 0.1 to 500 nm, more preferably 5 to 100 nm, even more preferably 10 to 100 nm. By forming a silver coat layer to a thickness of that range, the entire surface of the copper core particles can be covered with silver using a small amount of silver. The method for measuring the thickness of the silver coat layer will be described in Examples hereinafter given.

Provided that Expression (1) is satisfied, the silver-coated copper powder preferably has an S₁ (BET specific surface area) of 0.01 to 15.0 m²/g, more preferably 0.05 to 7.0 m²/g, even more preferably 0.1 to 2.0 m²/g, and an S₂ (specific surface area obtained through image analysis) of 0.01 to 15.0 m²/g, more preferably 0.05 to 7.0 m²/g, even more preferably 0.1 to 2.0 m²/g. The methods for measuring the BET specific surface area S₁ and the specific surface area S₂ will be described in Examples given infra.

In connection with the specific surface area S₂, it is preferred for the silver-coated copper particles of the silver-coated powder of the invention to have a D₅₀, a particle diameter as obtained by image analysis, of 0.05 to 50 μm, more preferably 0.1 to 10 μm, even more preferably 0.5 to 8 μm. In connection with the D₅₀, it is preferred for the silver-coated copper particles to have a volume cumulative particle diameter D_{50L} at a cumulative volume of 50 vol % as measured by laser diffraction-scattering method of 0.01 to 100 μm, more preferably 0.1 to 10 μm, even more preferably 0.5 to 10 μm. With the D₅₀ and D_{50L} falling within the above respective ranges, the silver-coated copper powder of the invention exhibits well-balanced conductivity and storage stability (i.e., protection against reduction in conductivity after long-term storage). The methods for measuring the D₅₀ and D_{50L} will be described in Examples.

As stated earlier, the silver-coated copper powder of the invention comprises copper core particles covered thinly with a silver coat layer. Therefore, there is no great difference between the particle size of the core particles and that of the silver-coated copper particles. The particle size of the core particles is preferably 0.01 to 50 μm, more preferably 0.1 to 10 μm, even more preferably 0.5 to 10 μm, in terms of volume cumulative particle diameter D_{50L} at a cumulative volume of 50 vol % measured by the laser diffraction-scattering particle size distribution analysis. The D_{50L} of the core particles is measured in the same manner as for the D_{50L} of the silver-coated copper particles.

As long as Expression (1) is satisfied, the silver-coated copper particles are not particularly limited in shape. It is generally preferred for the silver-coated copper particles to be spherical in the interest of the improvement on loadability and resultant improvement on conductivity but may have other shapes, such as flaky or spindle-shaped. The copper core particles are also preferably spherical.

The proportion of silver in the silver-coated copper powder is preferably 0.1 to 35 mass %, more preferably 0.5 to 30 mass %, even more preferably 0.5 to 25 mass %, for the balance between capability of covering the entire surface of the copper core particles and economic efficiency. The proportion of silver in the silver-coated copper powder is measured by, for example, completely dissolving the silver-coated copper powder in an acid and subjecting the solution to ICP emission analysis.

A suitable method for producing the silver-coated copper powder of the invention will then be described. The method includes providing copper core particles and forming a silver coat layer on the surface of the core particles. The method is characterized by the process for forming the silver coat layer. The silver coat layer formation is accomplished through the following two steps.

### Step 1:

Silver ions and copper core particles are brought into contact in water to conduct displacement plating thereby depositing silver on the surface of the core particles to form precursor particles.

### Step 2:

The precursor particles obtained in Step 1, silver ions, and a silver ion reducing agent are brought into contact with each other in water to further deposit silver on the surface of the precursor particles.

The core particles used in Step 1 are prepared by various processes. For example, the core particles may be obtained by reducing a copper compound, such as copper acetate or copper sulfate, using a reducing agent of various kinds, such as hydrazine, in a wet process. Otherwise, the core particles may be obtained by an atomizing process using molten copper. A preferred particle diameter and a preferred shape of the thus obtained core particles are as described supra. The core particles obtained by any of these processes are contacted with silver ions in water.

The silver ions are generated from a silver compound as a silver source. The silver compound may be a water soluble silver compound, such as silver nitrate. The silver ion concentration in water is preferably 0.01 to 10 mol/L, more preferably 0.04 to 2.0 mol/L, to cause a desired amount of silver to be deposited on the surface of core particles.

The amount of core particles in water is preferably 1 to 1000 g/L, more preferably 50 to 500 g/L, to cause a desired amount of silver to be deposited on the surface of core particles.

The order of addition of the core particles and the silver ions is not limited. For example, the core particles and the silver ions may be put into water simultaneously. For the ease of controlling deposition of silver through displacement plating, it is recommended that the core particles be previously dispersed in water to make a slurry, and the silver compound as a silver source be added to the slurry. In that case, the slurry may be at ambient temperature or a temperature between 0° and 80° C. Before the addition of the silver compound, a complexing agent, such as ethylenediamine tetraacetic acid, triethylenediamine, iminodiacetic acid, citric acid, or tartaric acid, or a salt thereof, may be added to the slurry for the purpose of controlling the reduction of silver.

The silver compound is preferably added in the form of its aqueous solution. The aqueous solution may be added to the slurry either at a time or continuously or discontinuously over a predetermined period of time. For ease of control of the displacement plating reaction, it is preferred that the silver compound aqueous solution be added to the slurry over a predetermined period of time.

Silver is deposited on the surface of the core particles by displacement plating to give precursor particles. In order to form a dense silver coat layer, the amount of the deposited silver of the precursor particles is preferably 0.1 to 50 mass %, more preferably 1 to 10 mass %, relative to the amount of silver of finally obtained silver-coated copper particles.

In Step 2, silver ions and a silver ion reducing agent are added to the slurry containing the precursor particles obtained in Step 1. The precursor particles obtained in Step 1 may be once separated from the liquid phase and then re-dispersed in water to make a slurry, or the slurry of the precursor particles as obtained in Step 1 may be subjected to Step 2. In the latter case, the slurry may or may not contain the residue of the silver ions added in Step 1.

The silver ions added in Step 2 are generated from the same water soluble silver compound as used in Step 1. The silver compound is preferably added to the slurry in the form of an aqueous solution. The silver ion concentration of the silver aqueous solution is preferably 0.01 to 10 mol/L, more preferably 0.1 to 2.0 mol/L. It is preferred for the formation of a dense silver coat layer that the silver aqueous solution having a concentration within the recited range be added in an amount of 0.1 to 55 parts, more preferably 1 to 25 parts, by mass per 100 parts by mass of the precursor particles in the slurry having the precursor particles concentration of 1 to 1000 g/L, preferably 50 to 500 g/L.

The reducing agent added in Step 2 is selected from those having such reducing power that allows displacement plating and reductive plating with silver to proceed simultaneously. A dense silver coat layer can be formed successfully by using such a reducing agent. If a reducing agent having strong reducing properties is used, reductive plating would proceed preferentially, making it difficult to form a silver coat layer with a desired dense structure. On the other hand, if a reducing agent having weak reducing properties is used, reductive plating with silver ions hardly proceeds, also resulting in difficulty in forming a silver coat layer with a dense structure. From these considerations, it is preferred to use an organic reducing agent that exhibits acidity when dissolved in water. Such a reducing agent is exemplified by formic acid, oxalic acid, L-ascorbic acid, erythorbic acid, and formaldehyde. These organic reducing agents may be used either individually or in combination of two or more thereof. Preferred of them is L-ascorbic acid. As used herein, the term “acidity” refers to a pH of 1 to 6 at 25° C. when 0.1 mol of an organic reducing agent is dissolved in 1000 g of water.

In order to facilitate simultaneous progress of displacement plating and reductive plating with silver, it is preferred to add the reducing agent in an amount of 0.5 to 5.0 equivalents, more preferably 1.0 to 2.0 equivalents, relative to the silver ions in the silver solution to be added.

The order of adding the reducing agent and silver ions to the slurry containing the precursor particles is not particularly limited. From the standpoint of forming a dense silver coat layer, addition of silver ions is preferably preceded by the addition of the reducing agent to the slurry. The silver compound as a silver source may be added to the slurry either at a time or continuously or discontinuously over a predetermined period of time. For ease of control of the reductive plating reaction, it is preferred that the silver compound be added in the form of an aqueous solution to the slurry over a predetermined period of time.

In Step 2, when displacement plating and reductive plating with silver are caused to proceed simultaneously, the slurry may be at ambient temperature or be previously heated to a temperature of 0° to 80° C.

In Step 2, a desired silver-coated copper powder is obtained by properly adjusting the reaction time and the silver ion concentration. The resulting silver-coated copper powder is suitably used in the form of a conductive composition. For example, the silver-coated copper powder may be mixed with a vehicle, a glass frit, and so on to prepare a conductive paste or mixed with an organic solvent and the like to prepare a conductive ink. The conductive paste or ink is applied patternwise onto a desired substrate to provide a patterned conductive film.

### EXAMPLES

The invention will now be illustrated in greater detail with reference to Examples, but it should be understood that the invention is not limited thereto.

### Example 1

A hundred grams of copper powder (1100Y from Mitsui Mining & Smelting, produced by a wet process; volume cumulative particle diameter D_{50L}, a diameter at a cumulative volume of 50 vol % measured by laser diffraction scattering method: 1.18 μm) was put in 500 ml of pure water heated to 40° C. to make a slurry. To the slurry was added 4.3 g of disodium ethylenediaminetetraacetate and dissolved while the slurry was stirred. To the slurry was further added 48 ml of a 0.44 mol/l aqueous solution of silver nitrate continuously over a period of 6 minutes to conduct displacement plating. Silver was thus deposited on the surface of the copper particles to give precursor particles.

L-Ascorbic acid was added as a reducing agent to the slurry and dissolved therein. Subsequently, 192 ml of a 0.44 mol/l aqueous solution of silver nitrate was added continuously over 24 minutes, whereby reductive plating and displacement plating proceeded simultaneously. Thus, silver was further deposited on the surface of the precursor particles to give a desired silver-coated copper powder.

### Examples 2 to 6

A silver-coated copper powder was obtained in the same manner as in Example 1, except for using copper powder having the particle size shown in Table 1 below and changing the concentration of silver nitrate in both the aqueous solution to be added to perform displacement plating and the aqueous solution to be added to simultaneously carry out displacement plating and reductive plating to 0.88 mol/l (Example 2), 0.04 mol/l (Example 3), 0.14 mol/l (Example 4), 0.22 mol/l (Example 5), or 0.40 mol/l (Example 6) to change the proportion of silver in the silver-coated copper powder.

### Comparative Example 1

Comparative Example 1 corresponds to Example 1, except that a silver-coated copper powder was produced only by displacement plating.

A hundred grams of copper powder (1100Y from Mitsui Mining & Smelting, produced by a wet process; volume cumulative particle diameter D_{50L}, a diameter at a cumulative volume of 50 vol % measured by laser diffraction scattering method: 1.18 μm) was put in 500 ml of pure water heated to 40° C. to make a slurry. To the slurry was added 4.3 g of disodium ethylenediaminetetraacetate and dissolved therein while the slurry was stirred, and 240 ml of a 0.44 mol/l aqueous solution of silver nitrate was then added thereto continuously over 30 minutes to carry out displacement plating. Silver was thus deposited on the surface of the copper particles to give a silver-coated copper powder.

### Comparative Examples 2 to 6

A silver-coated copper powder was obtained in the same manner as in Comparative Example 1, except for using copper powder with a particle size shown in Table 1 and changing the concentration of the silver nitrate aqueous solution for displacement plating to 0.88 mol/l (Comparative Example 2), 0.04 mol/l (Comparative Example 3), 0.14 mol/l (Comparative Example 4), 0.22 mol/l (Comparative Example 5), or 0.40 mol/l (Comparative Example 6) to change the proportion of silver in the silver-coated copper powder. Comparative Example 4 corresponds to Example 4.

### Comparative Example 7

Comparative Example 7 represents an example of the production of a silver-coated copper powder in which a reducing agent is added before the addition of a silver nitrate solution. The copper powder used is shown in Table 1. In 500 ml of pure water heated to 40° C. was put 100 g of the copper powder to make a slurry. To the slurry was added 4.3 g of disodium ethylenediaminetetraacetate and dissolved therein while the slurry was stirred. To the slurry was further added 240 ml of a 0.40 mol/l aqueous solution of silver nitrate continuously over a period of 30 minutes to carry out displacement plating and reductive plating thereby depositing silver on the surface of the copper particles. There was thus obtained a silver-coated copper powder.

### Comparative Example 8

Comparative Example 8 represents an example of the embodiment described in Patent Literature 2 (JP 2004-052044A), paras. [0023] and [0024] in which the copper powder shown in Table 1 below was used. One kilograms of the copper powder was dispersed in 2000 ml of a 15 g/l sulfuric acid aqueous solution, followed by decantation. To the resulting solid was added 80 g of ethylenediaminetetraacetic acid to prepare a copper slurry (total volume: 5000 ml). The copper slurry was then adjusted to pH 4 by dissolving potassium phthalate therein as a buffering agent. To the thus pH-adjusted copper slurry was added 2000 ml of a silver nitrate solution (prepared by dissolving 180 g of silver nitrate in water to make a total of 2000 ml) slowly over a period of 30 minutes to perform displacement reaction, followed by stirring for an additional period of 30 minutes to yield a silver-coated copper powder. The powder was collected by filtration, washed, and dewatered by suction to be separated from the liquid. After washing with water, the silver-coated copper powder was dried at 70° C. for 5 hours.

### Evaluation:

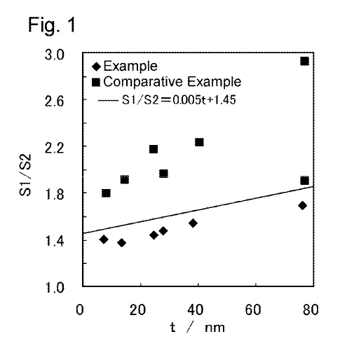

The silver-coated copper powder obtained in each of Examples and Comparative Examples was examined as follows. The amount of Ag (proportion of silver in the silver-coated copper powder in mass %) was determined by the method described above. The BET specific surface area S₁ was measured by the method described below. The volume cumulative particle diameter D_{50L} at a cumulative volume of 50 vol % was measured by laser diffraction-scattering method. The D₅₀ was calculated through image analysis, from which the specific surface area S₂ was calculated. Additionally, the L* value and powder resistivity of the silver-coated copper powder were determined. The measurement of powder resistivity was carried out immediately after the powder preparation and after an accelerated deterioration test. The results obtained are shown in Table 1. The graph of the relation between S₁/S₂ and t obtained by the measurement is shown in FIG. 1.

### BET Specific Surface Area S₁ of Silver-Coated Copper Powder

The silver-coated copper powder weighing 2.0 g was degassed at 75° C. for 10 minutes before measurement. Measurement was taken by the BET one-point method using MonoSorb from Quantachrome Instruments.

### D_{50L} of Silver-Coated Copper Powder by Laser Diffraction Scattering Method

A sample weighing 0.1 g was mixed with a 0.1 mass % aqueous solution of SN Dispersant 5469 (available from San Nopco Ltd.) and dispersed using an ultrasonic homogenizer US-300T (available from Nihonseiki Kaisha Ltd.) for 5 minutes. Thereafter, the particle size distribution was determined using a laser diffraction scattering particle size analyzer Microtrac HRA 9320-X100 (available from Leeds & Northrup).

### Average Particle Diameter D₅₀ of Silver-Coated Copper Powder by Image Analysis and D₅₀-Equivalent Specific Surface Area S₂

The average particle diameter D₅₀ by image analysis was obtained by providing an SEM image of the powder using an SEM at a magnification of 1000× to 10000×, obtaining particle diameters from the areas of the individual silver-coated copper particles (n≧100), and dividing the total of the particle diameters by the number of the particles. The specific surface area S₂ equivalent to the thus obtained D₅₀ was calculated from the following formula, where 10.49 is the density (g/cm³) of silver, and 8.92 is the density (g/cm³) of copper.

$${S}_{2} ( {m}^{2} \text{/} g ) = \frac{6}{( \begin{matrix}\frac{Amount of Ag ( mass \% ) \times 10.49}{100} + \\ \frac{( 100 - Amount of Ag ( mass \% ) \times 8.92 )}{100}\end{matrix} ) \times {D}_{50} ( µm )} \qquad [ Math . 1 ]$$

### Thickness of Silver Coat Layer

Thickness t of the silver coat layer thickness was calculated from the following formula:

$$t ( nm ) = \frac{Amount of Ag ( mass \% )}{100 \times {S}_{2} ( {m}^{2} \text{/} g ) \times 10.49} \qquad [ Math . 2 ]$$

### The L* Value of Silver-Coated Copper Powder

The L* value was measured using CM-3500D available from Konica Minolta Inc. The L* value serves as a measure of the uniformity of the silver coating on the surface of the copper core particles. The greater the L* value, the more uniform the silver coating.

### (6) Powder Resistivity of Silver-Coated Copper Powder

Fifteen grains of the silver-coated copper powder was pressed under a pressure of 500 kgf to make a 25 mm diameter pellet. The electrical resistance of the pellet was measured by the four-terminal method using PD-41 available from Dia Instruments Co., Ltd. The powder resistivity was measured immediately after the preparation of the silver-coated copper powder and after accelerated deterioration (the powder was allowed to stand in a shelf dryer at 150° C. for 75 hours). A change of powder resistivity was calculated from the powder resistivity R1 measured immediately after the preparation and the powder resistivity R2 measured after the accelerated deterioration. The change of powder resistivity is defined as “the powder resistivity R2 measured after the accelerated deterioration/the powder resistivity R1 measured immediately after the preparation”.

TABLE 1

| | | Laser Diffraction | Laser Diffraction | | Image Analysis | Specific Surface Area | |
|---|---|---|---|---|---|---|---|
| | | Diameter D_{50L} | Diameter D_{50L} | | Diameter D₅₀ | (m²/g) | |
| | | of Core | of Ag-coated | Amount | of Ag-coated | S₁ | S₂ |
| | | Particles | Copper particles | of Ag | Copper particles | (by BET | (by image |
| | | (μm) | (μm) | (mass %) | (μm) | method) | analysis) |
| Example | 1 | 1.18 | 1.00 | 10.3 | 0.93 | 0.99 | 0.71 |
| | 2 | 1.18 | 1.18 | 20.0 | 0.99 | 0.96 | 0.66 |
| | 3 | 6.44 | 6.61 | 1.0 | 5.24 | 0.18 | 0.13 |
| | 4 | 6.44 | 6.61 | 3.1 | 5.32 | 0.18 | 0.13 |
| | 5 | 6.44 | 6.65 | 4.8 | 5.40 | 0.19 | 0.12 |
| | 6 | 6.44 | 6.62 | 9.6 | 5.60 | 0.20 | 0.12 |
| Comparative | 1 | 1.18 | 1.00 | 10.6 | 0.97 | 1.30 | 0.68 |
| Example | 2 | 1.18 | 1.13 | 19.6 | 0.98 | 1.30 | 0.66 |
| | 3 | 6.44 | 6.37 | 1.1 | 5.24 | 0.23 | 0.13 |
| | 4 | 6.44 | 6.49 | 3.1 | 5.36 | 0.26 | 0.13 |
| | 5 | 6.44 | 6.53 | 5.1 | 5.50 | 0.27 | 0.12 |
| | 6 | 6.44 | 6.82 | 9.7 | 5.69 | 0.34 | 0.12 |
| | 7 | 6.44 | 6.78 | 9.5 | 5.30 | 0.26 | 0.13 |
| | 8 | 6.44 | 6.68 | 9.7 | 5.70 | 0.22 | 0.12 |

| | | | | Powder Resistivity (Ω · cm) | | | |
|---|---|---|---|---|---|---|---|
| | | | Ag Coat Layer | Immediately | after | Change of Pow- | |
| | | | Thickness | after | Accelerated | der Resistivity | L* |
| | | S₁/S₂ | (nm) | preparation | Deterioration | (%) | Value |
| Example | 1 | 1.37 | 13.6 | 1.31E−04 | 3.92E+00 | 29923.7 | 68.0 |
| | 2 | 1.47 | 28.0 | 1.43E−04 | 1.80E−03 | 12.6 | 71.9 |
| | 3 | 1.40 | 7.3 | 7.22E−05 | 2.00E−02 | 277.0 | 72.0 |
| | 4 | 1.44 | 24.6 | 6.12E−05 | 5.27E−04 | 8.6 | 77.8 |
| | 5 | 1.54 | 38.1 | 6.59E−05 | 2.59E−04 | 3.9 | 79.1 |
| | 6 | 1.69 | 76.2 | 6.89E−05 | 1.31E−04 | 1.9 | 79.8 |
| Comparative | 1 | 1.91 | 14.8 | 1.58E−04 | 5.12E+00 | 32405.1 | 65.0 |
| Example | 2 | 1.96 | 28.3 | 1.51E−04 | 2.36E−03 | 15.6 | 68.8 |
| | 3 | 1.79 | 8.1 | 8.98E−05 | 2.23E−01 | 2483.3 | 70.8 |
| | 4 | 2.17 | 24.6 | 1.02E−04 | 1.12E−03 | 11.0 | 75.3 |
| | 5 | 2.23 | 40.5 | 9.70E−05 | 5.80E−04 | 6.0 | 74.3 |
| | 6 | 2.93 | 77.0 | 9.95E−05 | 2.39E−04 | 2.4 | 73.5 |
| | 7 | 2.08 | 82.3 | 1.59E−04 | 4.82E−04 | 3.0 | 80.3 |
| | 8 | 1.90 | 77.0 | 9.01E−05 | 1.95E−04 | 2.2 | 78.3 |

As is apparent from the results shown in Table 1 and FIG. 1, the silver-coated copper powders of Examples (the products of the invention) have a lower powder resistivity as measured immediately after the preparation and after accelerated deterioration than those of Comparative Examples in the case the the particle size of the core particles is equal and the silver coat layer thickness is almost equal. The powders of Examples have a higher L* value than those of Comparative Examples, which indicates that the silver coat layer is formed more uniformly.

### INDUSTRIAL APPLICABILITY

The silver-coated copper powder of the invention has a silver coat layer formed on copper core particles uniformly and densely and therefore exhibits high electroconductivity. Since the core particles are hardly oxidized by virtue of the dense and uniform silver coat layer, reduction in conductivity with time is prevented. The production method according to the invention allows for easy production of such a silver-coated copper powder.

1. A silver-coated copper powder comprising copper core particles and a silver coat layer located on the surface of the core particles and satisfying Expression:
(S₁/S₂)≦0.005×t+1.45
where S₁ is a BET specific surface area (m²/g) of the silver-coated copper powder; S₂ is a specific surface area (m²/g) calculated from a particle diameter D₅₀ obtained by the analysis of a microscopic image of the silver-coated copper powder; and t is a thickness of the silver coat layer.

2. The silver-coated copper powder according to claim 1, having a volume cumulative particle diameter D_{50L} at a cumulative volume of 50 vol % as measured by laser diffraction-scattering method of 0.01 to 100 μm.

3. An electroconductive paste comprising the silver-coated copper powder according to claim 1.

4. A method for producing a silver-coated copper powder comprising the steps of:
contacting copper core particles with silver ions in water to conduct displacement plating to obtain precursor particles having silver deposited on the surface of the copper core particles and
contacting the precursor particles with silver ions and a silver ion reducing agent in water to further deposit silver on the surface of the precursor particles,
the reducing agent having such reducing power that allows displacement plating and reductive plating with silver to proceed simultaneously.

5. The method according to claim 4, wherein the reducing agent is an organic reducing agent exhibiting acidity when dissolved in water.

6. An electroconductive paste comprising the silver-coated copper powder according to claim 2.
